(19) United States
(12) Patent Application Publication
(10) Pub. No.: US 2009/0077857 A1
(43) Pub. Date: Mar. 26, 2009

(54) FISHING ROD AND METHOD FOR MAKING THE SAME

(76) Inventor: Wen-Hsiang Lee, Taichung County (TW)

Correspondence Address: MCNEES WALLACE & NURICK LLC, 100 PINE STREET, P.O. BOX 1166, HARRISBURG, PA, 17108-1166, US

(21) Appl. No.: 11/861,868

(22) Filed: Sep. 26, 2007

(51) Int. Cl. A01K 97/12; A01K 87/00

(52) U.S. Cl. 43/17; 43/18.1 R

(57) ABSTRACT

A fishing rod includes a longitudinal tube body, a vibration sensing unit including at least one elongated vibration sensing element mounted longitudinally on the tube body, and a butt guide mounted on the tube body and adapted to guide a fishing string. The butt guide is disposed over the vibration sensing element to transfer vibration movements of the fishing string to the vibration sensing element. A method for making the fishing rod is also disclosed.

### BACKGROUND OF THE INVENTION

1. Field of the Invention

The invention relates to a fishing rod, more particularly to a fishing rod having an improved vibration sensing capability to sense a strike. The invention also relates to a method for making the fishing rod.

2. Description of the Related Art

A conventional fishing rod includes a series of tapered hollow tubular sections made from blanks of fiber reinforced synthetic resin. Reel seats, grips, line guides, and tips are mounted on the rod blanks to make a finished fishing rod.

When fishing, it is usual that a vibration is generated on a fishing rod by a strike. However, it is frequent that the vibration is too small to be able to sense the strike. Conventionally, the strike is judged by the movement of a float. A fisherman can therefore not be quick and precise in action in response to the strike, thus failing to obtain a good result.

### SUMMARY OF THE INVENTION

Therefore, the object of the present invention is to provide a fishing rod having an improved vibration sensing capability to sense a strike.

In one aspect of this invention, a fishing rod includes a longitudinal tube body, a vibration sensing unit including at least one elongated vibration sensing element mounted longitudinally on the tube body, and a butt guide mounted on the tube body and adapted to guide a fishing string. The butt guide is disposed over the vibration sensing element to transfer vibration movements of the fishing string to the vibration sensing element.

In another aspect of this invention, a method for making a fishing rod includes the steps of:

A) winding a resin-impregnated composite sheet around a longitudinal mandrel to form a longitudinal tube body;

B) placing a vibration sensing element on the tube body along a longitudinal direction of the tube body;

C) positioning the vibration sensing element to the tube body;

D) heating the vibration sensing element and the tube body to cure the tube body and to bond the vibration sensing element to the tube body; and

E) removing the tube body from the mandrel after curing.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary sectional view of a preferred embodiment of a fishing rod according to this invention;

FIG. 2 is another sectional view of the preferred embodiment taken along line II-II of FIG. 1; and

FIGS. 3 to 9 are different views showing consecutive steps of a preferred embodiment of a method for making a fishing rod.

### DETAILED DESCRIPTION OF THE PREFERRED EMBODIMENTS

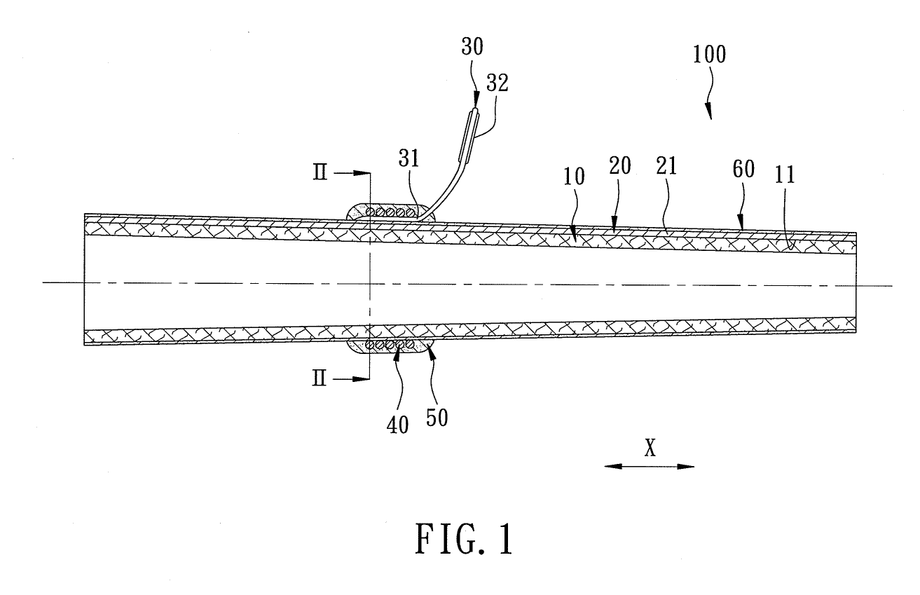

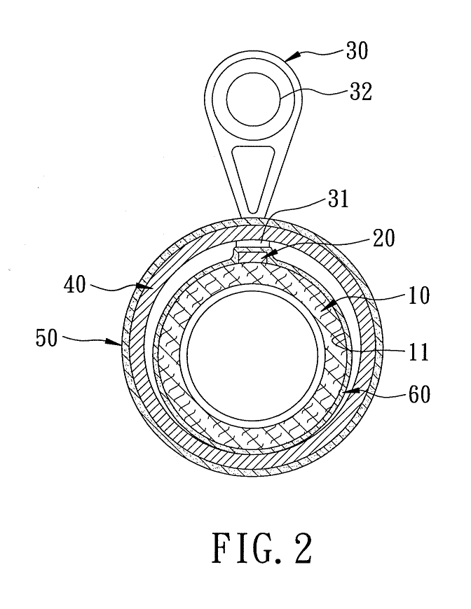

Referring to FIGS. 1 and 2, the preferred embodiment of a fishing rod 100 according to this invention is shown to include a longitudinal tube body 10, a vibration sensing unit 20 mounted longitudinally on the tube body 10, an outer coating layer 60, a butt guide 30 mounted on the tube body 10 and adapted to guide a fishing string (not shown), a tying wire 40, and a protective coating 50 disposed around the tying wire 40.

The longitudinal tube body 10 is made of a resin-impregnated sheet of carbon-fiber or glass-fiber composite, extends along a longitudinal direction (X) and has an outer surface 11.

The vibration sensing unit 20 includes an elongate vibration sensing element 21 mounted longitudinally on the outer surface 11 of the tube body 10. Additionally, the vibration sensing unit 20 can include a plurality of the vibration sensing elements 21 transversely spaced apart from each other. The vibration sensing element 21 is made of a material having high density and sensibility. The material useful as the vibration sensing element 21 is a carbon strip, a carbon wire, a metal strip, a metal wire, or the like.

The outer coating layer 60 is disposed around and contacts the tube body 10 and the vibration sensing element 21.

The butt guide 30 is disposed over the vibration sensing element 21 to transfer vibration movements of the fishing string to the vibration sensing element 21. The butt guide 30 includes a seat portion 31 contacting a portion of the outer coating layer 60 that contacts the vibration sensing element 21, and a guide ring 32 extending outwardly from the seat portion 31. The vibration sensing element 21 extends between the seat portion 31 of the butt guide 30 and the outer coating layer 60.

The tying wire 40 is wound around the tube body 10 to tie the seat portion 31 of the butt guide 30 to the tube body 10. In the preferred embodiment, the tying wire 40 is made of cotton.

The protective coating 50 is made of an epoxy resin, and is used to prevent loosening or rotting of the tying wire 40.

The vibration movements of the fishing string resulted from the strike of a fish can be transferred to a hand of a fisherman via the butt guide 30 and the vibration sensing element 21. Therefore, the vibration sensing capability to sense a strike can be improved.

Referring to FIGS. 1 and 3 to 9, the preferred embodiment of a method for making the fishing rod 100 includes the steps of:

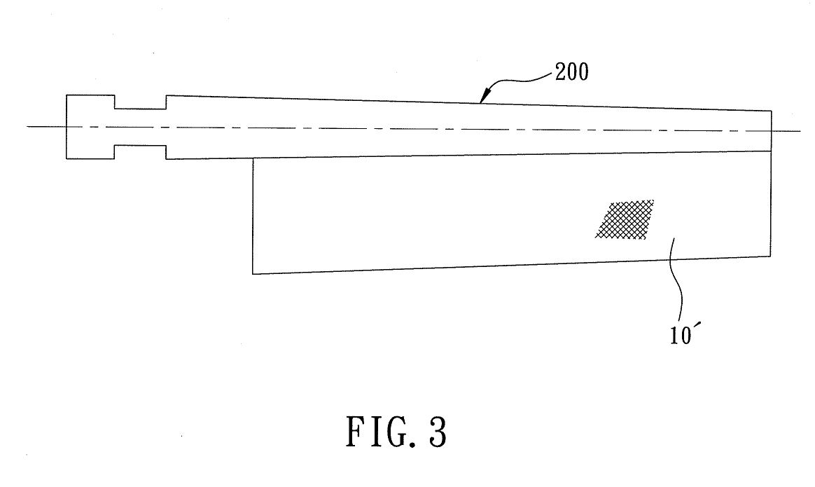

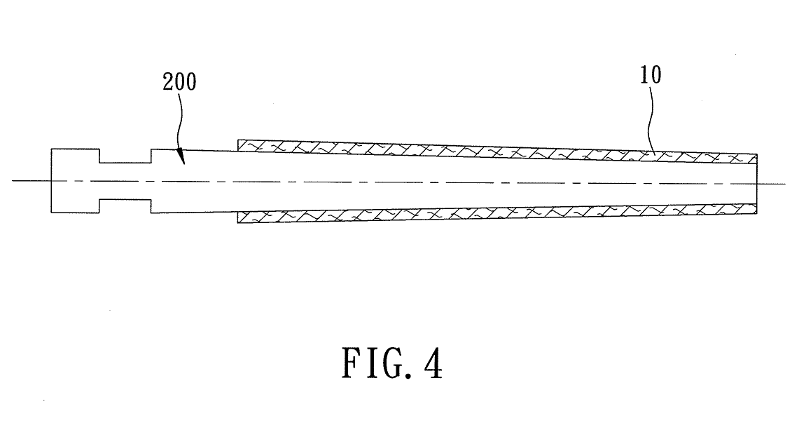

A) winding a resin-impregnated composite sheet:
Specifically referring to FIGS. 3 and 4, the resin-impregnated composite sheet 10′ is wound around a longitudinal mandrel 200 to form a longitudinal tube body 10.

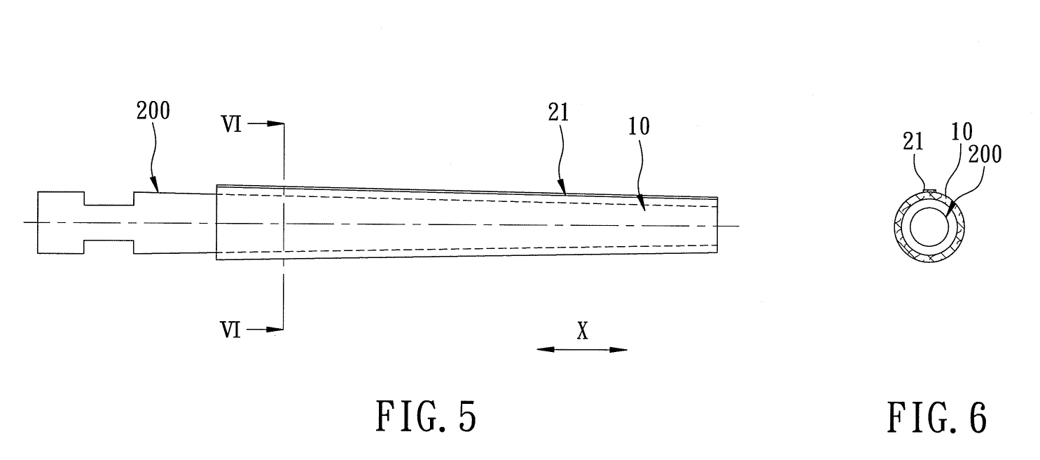

B) placing a vibration sensing element:
Specifically referring to FIGS. 5 and 6, the vibration sensing element 21 is placed on the tube body 10 along the longitudinal direction (X) of the tube body 10.

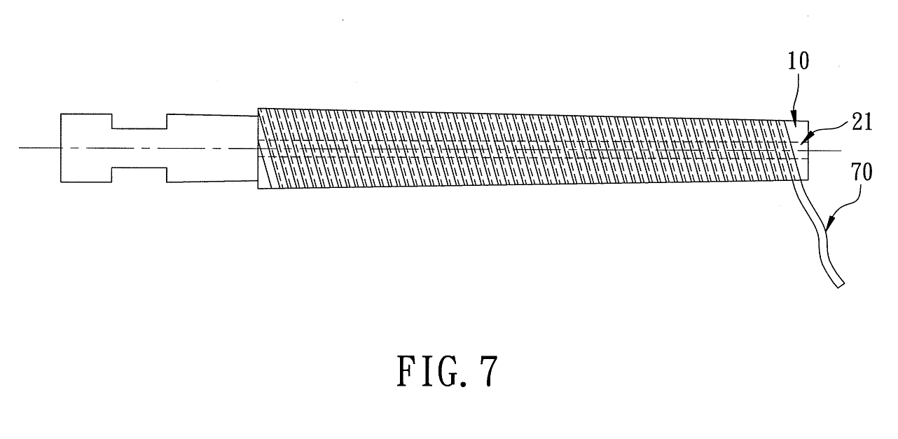

C) positioning the vibration sensing element:
Specifically referring to FIG. 7, the vibration sensing element 21 is positioned to the tube body 10 by winding helically a polymeric strip 70 around the vibration sensing element 21 and the tube body 10.

D) heating the vibration sensing element and the tube body:
The vibration sensing element 21 and the tube body 10 are heated at a temperature ranging from 120 to 150° C., preferably from 130 to 140° C., to cure the tube body 10 and to bond the vibration sensing element 21 to the tube body 10.

E) removing the tube body from the mandrel:
The tube body 10 is removed from the mandrel 200 after curing. The polymeric strip 70 is then removed from the tube body 10.

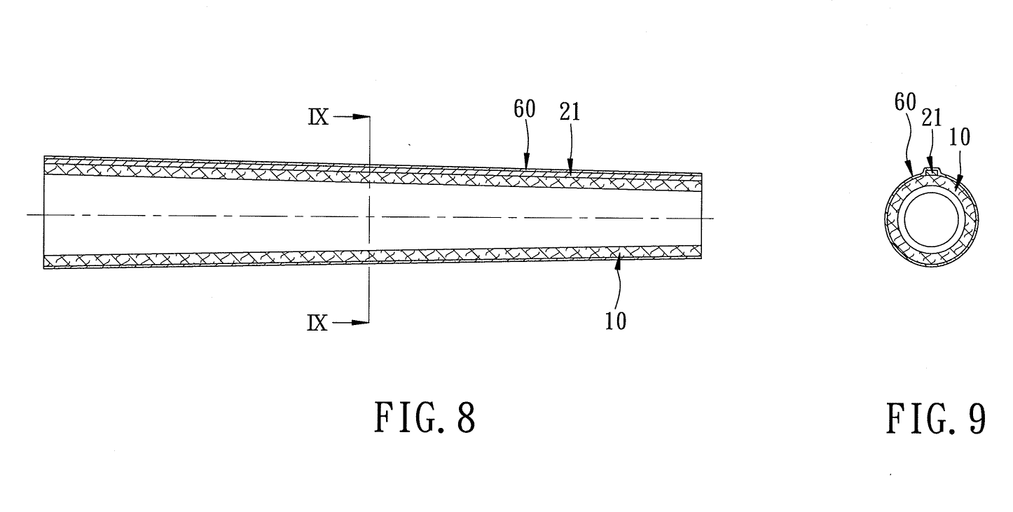

F) providing an outer coating layer:
Specifically referring to FIGS. 8 and 9, the outer coating layer 60 in contact with the tube body 10 and the vibration sensing element 21 is provided so as to improve aesthetic appearance of the tube body 10.

G) tying a butt guide:
Specifically referring to FIG. 1, the butt guide 30 is placed over the outer coating layer 60 at a portion which contacts the vibration sensing element 21, and is tied on the tube body 10 using the tying wire 40 to wind around the seat portion 31 of the butt guide 30 and the tube body 10 so that the seat portion 31 of the butt guide 30 makes contact with a portion of the outer coating layer 60 that contacts the vibration sensing element 21.

H) applying a protective coating:
The protective coating 50 is applied on the tying wire 40.

I) baking the protective coating:
The protective coating 50 is baked at a temperature ranging from 50 to 85° C.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A fishing rod, comprising:
a longitudinal tube body;
a vibration sensing unit including at least one elongated vibration sensing element mounted longitudinally on said tube body; and
a butt guide mounted on said tube body and adapted to guide a fishing string, said butt guide being disposed over said vibration sensing element to transfer vibration movements of the fishing string to said vibration sensing element.

2. The fishing rod as claimed in claim 1, wherein said vibration sensing unit includes a plurality of said vibration sensing elements transversely spaced apart from each other.

3. The fishing rod as claimed in claim 1, wherein said vibration sensing element is made of a material selected from the group consisting of a carbon strip, a carbon wire, a metal strip and a metal wire.

4. The fishing rod as claimed in claim 3, further including an outer coating layer disposed around and contacting said tube body and said vibration sensing element.

5. The fishing rod as claimed in claim 4, wherein said butt guide includes a seat portion contacting a portion of said outer coating layer that contacts said vibration sensing element, and a guide ring extending outwardly from said seat portion, said vibration sensing element extending between said seat portion of said butt guide and said outer coating layer.

6. The fishing rod as claimed in claim 5, further comprising a tying wire wound around said tube body to tie said seat portion of said butt guide to said tube body, and a protective coating disposed around said tying wire.

7. The fishing rod as claimed in claim 6, wherein said protective coating is made of an epoxy resin.

8. A method for making a fishing rod, comprising the steps of:
A) winding a resin-impregnated composite sheet around a longitudinal mandrel to form a longitudinal tube body;
B) placing a vibration sensing element on the tube body along a longitudinal direction of the tube body;
C) positioning the vibration sensing element to the tube body;
D) heating the vibration sensing element and the tube body to cure the tube body and to bond the vibration sensing element to the tube body; and
E) removing the tube body from the mandrel after curing.

9. The method as claimed in claim 8, wherein the step C) is conducted by winding helically a polymeric strip around the vibration sensing element and the tube body, the polymeric strip being removed from the tube body after the step E).

10. The method as claimed in claim 9, further comprising a step of providing an outer coating layer in contact with the tube body and the vibration sensing element.

11. The method as claimed in claim 10, further comprising a step of tying a butt guide on the tube body and contacting a seat portion of the butt guide with a portion of the outer coating layer that contacts the vibration sensing element.

12. The method as claimed in claim 11, wherein a wire is wound around the seat portion of the butt guide and the tube body to tie the butt guide.

13. The method as claimed in claim 12, further comprising a step of applying a protective coating on the wound wire.

14. The method as claimed in claim 13, further comprising a step of baking the protective coating.

15. The method as claimed in claim 14, wherein the baking step is conducted at a temperature ranging from 50 to 85° C.

16. The method as claimed in claim 8, wherein the step D) is conducted at a temperature ranging from 120 to 150° C.
